(19) United States
(12) Patent Application Publication
(10) Pub. No.: US 2005/0230496 A1
(43) Pub. Date: Oct. 20, 2005

(54) Paint composition and paint spraying apparatus with preheated paint

(76) Inventors: David George Gill, Welshpool Powys (GB); Sheila Gill, Welshpool Powys (GB); Johannes Jules Verhoosel, Uithoom (NL); Hans Meeuwissen, Uithoorn (NL)

Correspondence Address: McDermott Will & Emery, 600 13th Street NW, Washington, DC, 20005-3096, US

(21) Appl. No.: 10/499,153

(22) PCT Filed: Dec. 19, 2002
(86) PCT No.: PCT/GB02/05784

§ 371 Date: Apr. 22, 2005

(30) Foreign Application Priority Data
Dec. 19, 2001 (GB) 01303205
Feb. 28, 2002 (GB) 02047272

(51) Int. Cl. B05C 1/00

(52) U.S. Cl. 239/135

(57) ABSTRACT

This invention describes the development of a novel spray paint High Volume Low Pressure (HVLP) apparatus including a membrane pump to allow for the handling of higher viscosity paint to facilitate high layer-thickness applications (typically in a single paint application) with a marked reduction in over-spray. The apparatus functions by using heated air and allows for heating of waterborne paints and in particular a novel waterborne paint also the subject of this application. This waterborne paint provides for better levelling, drawing and application of the paint product to a desired substrate. The paint product claimed in the invention has a product to a desired substrate. The paint product claimed in the invention has a viscosity profile tailored for use with the spraying apparatus of the present invention. A further aspect of the present invention comprises the combination of the painting apparatus and the sprayable paint product as an effective integrated painting system.

### TECHNICAL FIELD OF THE INVENTION

The present invention relates to a novel system of paint application for use both indoors and outdoors.

### BACKGROUND

Paints and other types of coating materials have long been used to protect surfaces and for decorative purposes. Solvent based materials have been widely used in the past because of their durability and fast drying properties. They have over the years fallen into disfavour for interior uses because of their release of environmentally dangerous and polluting organic solvents into the atmosphere. More recently on the scene are waterborne decorative coatings which have received great applause because of their environmental friendliness. In certain jurisdictions the use of waterborne products is now mandatory for interior use as is currently the case in The Netherlands and other European countries.

Even though significant improvements have been made to waterborne paints over the years, nevertheless the application of waterborne paints is still far from perfect. For instance, especially for decorative purposes (i.e. painting interiors within the home), waterborne paints are typically applied by using traditional paint brush and roller techniques. Not only is this application method extremely time consuming, but it can be more expensive since there is often a requirement for a minimum of two (2) if not multiple layers or coatings of paint to be applied in order to achieve the desired aesthetic effect on the surface or substrate.

In applying paint, typical industry standards (and for that matter standards demanded by consumers or professional painters/decorators) are that the paint applied (whether waterborne or solvent based) to the desired surface or substrate should be of a sufficient durability and meet a minimum level of aesthetic performance in the areas of smooth coating surface (i.e. application results in a level coating surface); avoiding sagging (i.e. downward movement of the paint film between the time of application and setting resulting in an uneven surface) often caused by the paint drying too slowly or the paint being of too low viscosity or the paint film being applied in too thick a fashion. This latter performance criteria is often an issue when using standard brushing or rolling techniques. There is also a requirement that any paint applied should have a proper level of opacity caused by sufficient layer-thickness of paint. It is also highly desirable for the paint application to have a level of “cleanliness” (i.e. avoiding fouling of adjacent objects or surfaces typically accomplished through use of precise paint brush application or pre-masking for spray application of the paint).

In addition to the aesthetic requirements demanded by consumers and professional decorators there exists the need for the paint to be applied in a cost-effective and less time-consuming fashion. One of the complicating factors of the equation is that there are fewer and fewer skilled craftsmen in the painting industry and therefore the need for reducing time spent on each project as well as increasing the intervals between repainting requirements is becoming ever more critical in this industry sector.

To assist craftsmen there have been developed various means of spray painting using a gun-type apparatus. Both waterborne and solvent-based paints may be applied to a surface by atomisation in a spray gun using, for example, a high pressure medium such as compressed air often with mixed results. For traditional or standard brushing or rolling techniques it is often possible to apply a single relatively thick coating of paint of up to 200 microns but if this was attempted using a spraying technique with waterborne paints this could result in a problem. This is due to the fact that standard waterborne paints are often very slow to dry and can result in sagging on the finished surface or substrate. This problem is often worsened since standard paints are typically thinned down in order to be spray applied. As a result of these concerns, waterborne paints are rarely used in conjunction with spray painting. Unfortunately, waterborne paints are therefore still typically applied by brush or through use of a roller resulting in only average aesthetic results (these paints are more sensitive to brush marks and layer-thickness variations) and the expenditure of a great amount of time with the painting activity itself. Even though using of spray application techniques results in a larger area of coated surface in less amount of time than manual brush and roller applications, any economy with time is typically lost with the painstaking requirements for masking and covering any surfaces or substrates that are not desired to be coated.

The use of spray guns also creates its own series of environmental and economical concerns since it is highly desirable that any over-spray of paint and bounce-back be limited to a minimum. Another form of spraying is the so-called HVLP (High Volume-Low Pressure). HVLP provides spray efficiency (or transfer efficiency) to substrate of between 65% and 90%, whereas conventional high-pressure spray guns typically only achieve a transfer efficiency of between 25% to 30%. HVLP though typically only works using lower viscosity/higher solvent products—thus again rules out using standard waterborne paints with HVLP as these paints are quite viscous in nature. Additionally, the application of thick paint layers of up to 200 microns are desirable for reasons of both durability and aesthetics (as well as being desirable for economic and time-saving reasons) are not possible with HVLP. Use of HVLP at present is not recommended with current waterborne products (e.g. waterborne lacquered products) because the end results is often sagging and lacks the desired smoothness. Further drawbacks with standard HVLP equipment is resulting amount of over-spray which can be considerable and limited layer-thickness build up. This would present obvious problems when a user is required to paint a large substrate area

Currently available products and apparatuses are clearly unable to provide what craftsmen in the highly competitive decorative market truly require: rapid coverage of a desired surface or substrate through use of a spraying apparatus that accommodates waterborne products resulting in a surface painted to high aesthetic standards (even beyond those aesthetic standards more readily acquired through using traditional brushing and rolling techniques) with little over-spray. Such a comprehensive system does not exist at present.

### SUMMARY OF THE INVENTION

The present invention resolves this long-felt problem through use of a combination of novel solutions to the specific problems identified above currently facing the paint and decorating industry. The present invention combines the use of a novel waterborne paint which may then be applied using a novel spraying apparatus resulting in a fast and efficient process as well as being aesthetically pleasing for painting large or small surface areas.

The first aspect of the invention is the development of a novel spray paint apparatus incorporating many of the desirable features of a traditional HVLP apparatus, but further including a membrane pump to allow for the handling of higher viscosity paint to facilitate high layer-thickness applications (typically in a single application) with a marked reduction in over-spray. The apparatus of the present invention functions by using heated air, and comprises a paint and paint transportation system to allow the handling of higher viscous paints and resulting in good levelling, rapid drying and a good build up in the layer of the applied paint to the surface or substrate. This system incorporates a heat exchanger utilising the hot air generated through use of the engine motor of the spraying apparatus. The hot air is fed along or passed over a coil, the coil forming a conduit for the paint. The heating of the paint provides for better levelling, drying and application of the desired paint product.

A further aspect of the present invention, is an improved waterborne paint with a viscosity profile tailored for use with the novel spraying apparatus of the present invention. This novel product though is not limited for use solely with the apparatus described in this invention. The novel paint of the present invention results in the desired characteristics of being faster drying, minimal sagging, good levelling and maintains all the technical and environmental advantages of standard waterborne paint and decorating products.

An additional aspect of the present invention comprises the combination of the above-mentioned aspects resulting in a unique and highly effective complete painting system.

### BRIEF DESCRIPTION OF THE DRAWINGS

The following description and the accompanying drawings referred to therein are included by way of non-limiting embodiments.

FIG. 1 illustrates a paint spraying apparatus of the present invention.

FIG. 2 illustrates an axial section through the heat exchanger for use with the apparatus of the present invention

FIG. 3 illustrates a mobile trolley unit incorporating the paint apparatus of the present invention.

### DETAILED DESCRIPTION OF THE INVENTION

In order to overcome the aesthetic problems in using waterborne products with spraying apparatus, it has been found that pre-heating the paint material before application or atomisation results in a more uniform finish and levelling and allows a thicker coat of the paint material to be applied.

The apparatus of the present invention is the subject of a separate priority application filed 19 Dec. 2001 at the United Kingdom Patent Office being assigned application no. 0130320.5, and also of a separate priority application filed 28 Feb. 2002 at the United Kingdom Patent Office being assigned application no. 0204727.2. These applications and all features described therein are hereby incorporated by reference into the present application.

In a first embodiment of the present invention the paint material is pre-heated by means of an indirect heat exchanger. The heating medium is typically air, although not necessarily confined to this medium. After passing through the heat exchanger the heating medium is preferably supplied to the spray gun for use in atomising the preheated material. Since the heating medium thus supplies additional heat to the region of application, the quality of the coating is improved and the energy efficiency of the apparatus is increased.

The heating medium may be warmed using various methods before reaching the heat exchanger, for example by using an electrical heating element. However, it is preferred to heat the medium by passing it through a turbine. This has the advantage that it produces large volumes of heated air at a low pressure compared with a standard air compressor, thus reducing the effects of over-spray and bounce back when applying the paint material.

The indirect heat exchanger preferably has a housing which defines a vortex chamber through which the heating medium passes and the atomisable material passes through a heat-exchange conduit disposed within the chamber. The vortex chamber is preferably of a general cylindrical shape and can have concave ends. This however is certainly not mandatory and a person skilled in the art would be able to alter the overall shape or configuration without having an input on the efficiency of the vortex chamber. Specifically, the shape of the chamber creates a vortex in order that the warmed air can freely circulate around the chamber a number of times before leaving the chamber. The heat-exchange conduit is preferably coiled within the vortex chamber.

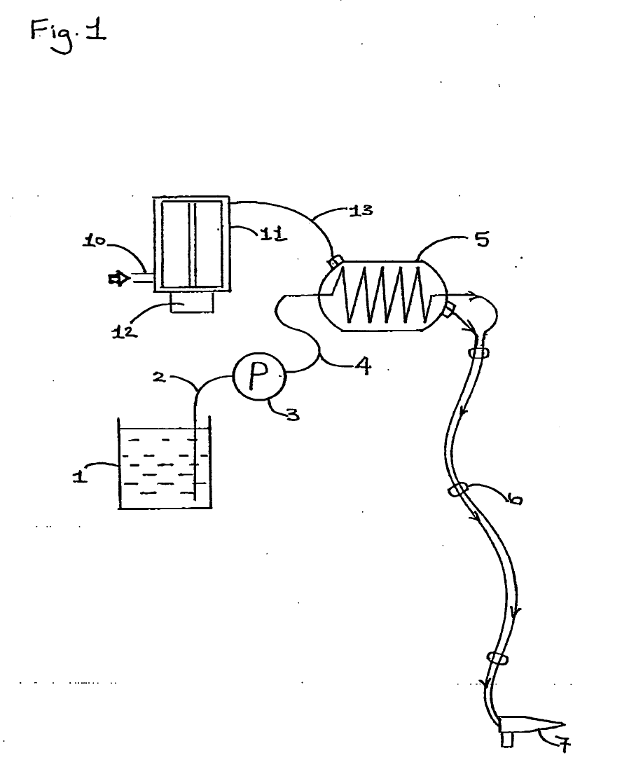

Referring to FIG. 1, paint is drawn from a reservoir (1) which can be a paint can or trough through a flexible tube (2) by means of a suitable electrically or pneumatically operated pumping mechanism (3), for example a diaphragm pump. The pump feeds the paint via a pipe (4) to be heated by passing through the secondary of an indirect heat exchanger (5). After departing from the heat exchanger the paint travels along and through a flexible hose (6) to a spray gun and nozzle (7). The length of the flexible conduit such as a hose or tube (6) may be varied in order to provide the user of the spraying apparatus a suitable length of flexible hose so as not to interfere or inhibit the mobility of the user or the apparatus. The diaphragm pump may also contain a pulsation damper and filter unit.

Atmospheric air is drawn through an inlet (10) into a turbine (11) which is driven at high speed by an electric or pneumatic motor (12), typically operating at about 22,000 rpm. The turbine for instance can be a simple brush electric motor. On passage through the turbine the air is warmed typically to the order of 20° C. above ambient temperature by generating friction and compression producing a large volume of warmed air at a relatively low pressure. The level of rise above ambient temperature can be dependent on the paint material being applied and therefore should be of a sufficient amount to allow a uniform finish and levelling and a thicker coat of the paint material to be applied to the substrate. This warmed air passes through a pipe (13) to the heat exchanger (5) where the air gives up a proportion of its heat to the paint passing through the secondary of the heat exchanger. Exhaust air from the heat exchanger passes along a separate duct of the hose (6) to the spray gun and nozzle (7), where the air flow is used to atomise the warm paint into a fine spray of droplets interspersed with the warm air flow.

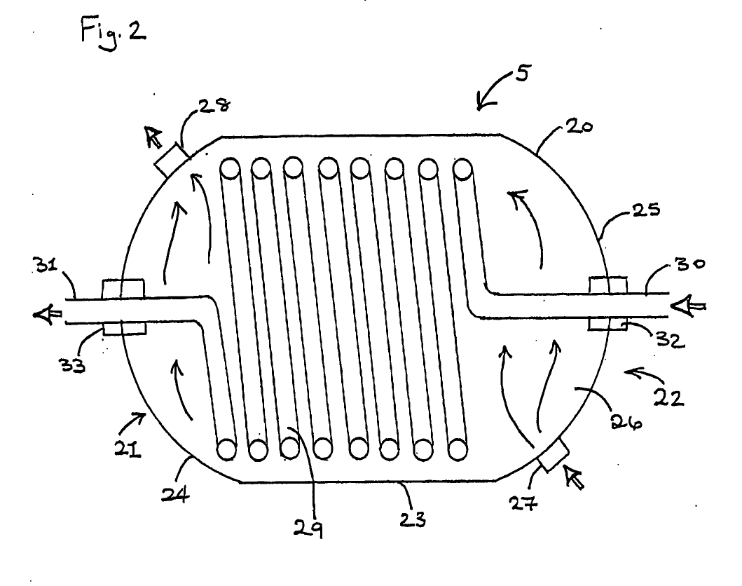

FIG. 2 illustrates a heat exchanger of the present invention. The heat exchanger has a housing (20) formed by two concave spun parts (21 and 22) providing a cylindrical side wall (23) with concave end walls (24 and 25). Warmed air from the turbine enters the chamber (26) formed within the housing through an off-centre inlet connection (27) in one of the end walls (25) and leaves through a similar off-centre outlet connection (28) in the other end wall (24). The elongated-spherical shape of the housing creates a vortex within the housing so that the air circulates around the chamber a number of times before leaving the chamber. The secondary of the heat exchanger forms a stainless steel tube (29) which is coiled into a cylindrical shape and supported co-axially within the housing (20) by means of threaded ends. It should be appreciated by one skilled in the art that use of materials other than stainless steel for the tube (29) would be acceptable.

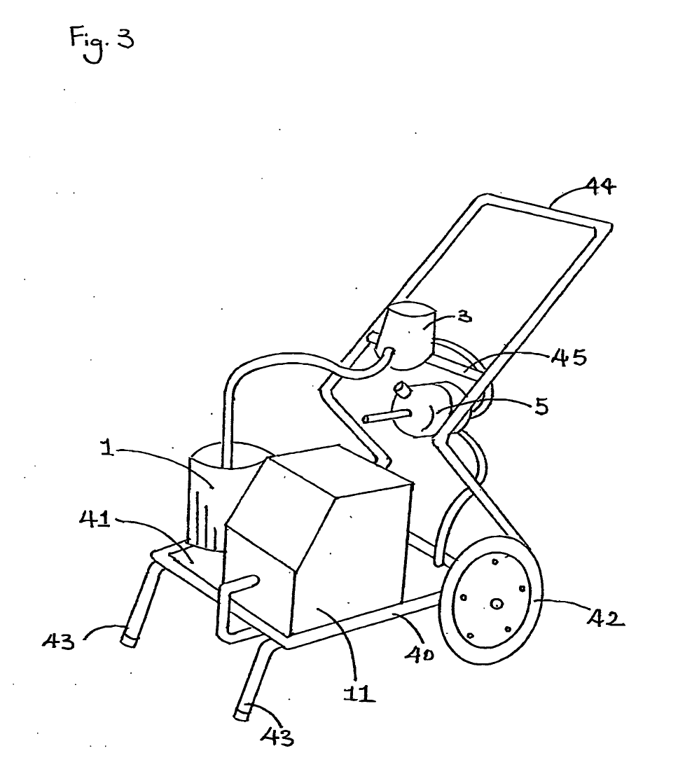

The spraying apparatus can also be housed in a cart for ease of mobility as illustrated in FIG. 3.

Although the apparatus of the present invention has been developed based on certain principles of standard HVLP machinery, a similar design based on Low Volume Low Pressure (LVLP) would also be acceptable.

The second aspect of the present invention is the provision of a novel sprayable coating (paint) material. The paint material although designed for use in conjunction with the above-described spraying apparatus and is waterborne in basis, is also suitable for use with other spraying mechanisms or apparatus or use by a conventional compressed (high pressure) air system or LVLP system so long as the claimed paint is pre-heated before application or atomisation.

One of the advantages of the specially developed paint material of the present invention is that when used by a spraying apparatus, and in particular the novel paint apparatus of the present invention the wet film thickness reaches a typically uniform level of approximately 200 microns compared to the previous wet film thickness found in using conventional satin paint products of approximately 100 microns. The wet film thickness of standard satin paint products can be as low as 40 microns to 50 microns when sprayed, which can result in a requirement for additional layers (upwards to an extra 2 coats of paint material) being applied. This is not advantageous or cost effective for decorative or industry-related purposes. The applicant has identified certain important criteria or parameters that optimise the sprayable nature of waterborne paint materials on substrates. By identifying these parameters which have never before been identified, the invention therefore supplies a paint requiring only a single application (by use of a spraying apparatus) of waterborne paint material is required and the aesthetic results are far superior to those experienced with standard waterborne paint products.

The paint of the present invention is a modified waterborne paint and must meet three criteria. The sprayable paint must possess low shear viscosity, sag resistance and satisfactory wet film thickness after spraying. For instance, the shear viscosity can be measured using a HAAKE VT181 viscosimeter using a cylindrically shaped spindle.

It was determined that a suitable viscosity at a rotation speed of 181 rpm is approximately 5-30 dPa·s, preferably at approximately 10-25 dPa·s under conditions of 23° C. and 50% RH. A particularly preferred viscosity is in the region of approximately 15-22 dPa·s and an optimal viscosity for the higher shear at approximately 17-20 dPa·s. A low shear viscosity is assessed at a speed of 5.6 rpm is approximately 50-250 dPa·s, or preferably at approximately 80-200 dPa·s or more preferably at approximately 110-170 dPa·s with an optimal low shear viscosity of around 130-150 dPa·s.

Resistance to sagging is determined for instance using a multinotch applicator such as an ASTM D 4400 and can be analysed on an index basis. The inventors have discovered that waterborne paint suitable for spraying, particularly with the apparatus described in the present invention, should have an anti-sag index rating of between approximately 500 μm to 1100 μm, and preferably, between approximately 700 μm to approximately 800 μm.

Finally, wet film thickness after spray application of the paint should range from approximately 200 μm to approximately 700 μm. The wet film thickness can be determined, for instance, by measurements from an ASTM D machine.

Particularly preferred waterborne paints of the present invention are polyurethane modified acrylics.

As a final aspect of the present invention is the use of the novel spray painting apparatus in combination or interlinked with the novel sprayable coating material. An integrated system is a highly unique concept in the painting and decorating industry which has typically developed through the generation of so-called stand alone products or features rather than the development of integrated systems. The advantages of the claimed combination invention are in the savings in labour time and costs, limited over-spray of the paint, consistent results, and high levels of layer-thickness per application of paint thus resulting in a single application of the novel paint. The overall result of fusing the spraying apparatus and the waterborne paint of the present invention is that excellent aesthetic and technical improvements are achieved even above that observed using traditional brush and roller techniques and is delivered at a lower cost.

It will be appreciated that the features disclosed herein may be present in any feasible combination. Whilst the above description sets out the emphasis on those areas which, in combination, are believed to be new and inventive, protection is claimed for any inventive combination of the features disclosed herein.

1. A paint spraying apparatus in which an atomisable material to be sprayed is pre-heated before being supplied to a spray gun.

2. An apparatus according to claim 1, designed so to act as a HVLP apparatus.

3. An apparatus according to claim 1 or claim 2, further comprising a membrane pump.

4. An apparatus according to claim 3 in which the membrane pump is fitted with a pulsation damper and filter unit

5. An apparatus according to claim 3 or claim 4, capable of applying high viscosity paints.

6. An apparatus according to any one of claims 1 to 5, in which the atomisable material is heated via means of an indirect heat exchanger.

7. An apparatus according to claim 6, in which the heating medium is a gas.

8. An apparatus according to claim 6, in which the heating medium is air.

9. An apparatus according to claim 6, in which the heating medium is heated by means of a turbine.

10. An apparatus according to claim 9 in which the turbine operates about 22,000 rpm.

11. An apparatus according to claims 9 or 10 in which the turbine is a brush electric motor.

12. An apparatus according to any on of claims 9, 10 or 11, wherein the air on passage through the turbine is warmed above ambient temperature to allow the paint material to be applied uniformly and in a single coat.

13. An apparatus according to any one of claims 9 to 12, wherein the air is warmed 20° C. above ambient temperature.

14. An apparatus according to any one of claims 6 to 13, in which the heating medium is supplied to the spray gun for use in atomising the pre-heated material.

15. An apparatus according to any one of claims 6 to 14, in which the indirect heat exchanger comprises a housing defining a vortex chamber.

16. An apparatus according to claim 15, in which the heating medium passes through the vortex chamber.

17. An apparatus according to claim 16 in which the heating medium enters the vortex chamber through an off centre inlet in one end of the heat exchanger wall, and leaves through an off centre outlet in an opposing heat exchanger wall.

18. An apparatus according to any one of claims 15, 16 or 17, wherein the atomisable material passes through a heat exchanger secondary disposed within the vortex chamber.

19. An apparatus according to claim 18 in which the secondary heat exchanger is a stainless steel tube

20. An apparatus according to any one of claims 15 to 18, wherein the vortex chamber is generally cylindrical.

21. An apparatus according to any one of claims 1 to 20, wherein a flexible hose of varied length connects the spray gun to the apparatus.

22. An apparatus according to any of claims 1 to 21, adapted so as to be used as a low volume, low pressure device.

23. An apparatus according to any of claims 1 to 22, housed on a cart.

24. The use of an apparatus as defined in any one of claims 1 to 23, for the application of paint.

25. The use of an apparatus as defined in claim 24, wherein the paint is a waterborne paint, preferably a polyurethane modified acrylic paint.

26. The use of an apparatus according to claim 24 or 25, in which the over-spray of paint is reduced as compared with previously known means of spraying application.

27. A waterborne paint capable of being applied by HVLP spraying to a desired substrate or surface.

28. A paint according to claim 27 having a viscosity in the range of approximately 5 dPa·s to approximately 30 dPa·s when measured at a rotation speed of 181 rpm.

29. A paint according to claim 27 or claim 28, wherein the viscosity is in the range of approximately 10 dPa·s to approximately 25 dPa·s when measured at a rotation speed of 181 rpm.

30. A paint according to any on of claims 27, 28 or 29, wherein the viscosity is in the range of approximately 15 dPa·s to approximately 22 dPa·s when measured at a rotation speed of 181 rpm.

31. A paint according to any one of claims 27 to 30, wherein the viscosity is in the range of approximately 17 dPa·s to approximately 20 dPa·s when measured at a rotation speed of 181 rpm.

32. A paint according to claim 27 having a low shear viscosity in the range of approximately 50 dPa·s to approximately 250 dPa·s when measured at a rotation speed of 5.6 rpm.

33. A paint according to any claim 32 having a low shear viscosity in the range of approximately 80 dPa·s to approximately 200 dPa·s. when measured at a rotation speed of 5.6 rpm

34. A paint according to claim 32 or 33 having a low shear viscosity in the range of approximately 110 dPa·s to approximately 170 dPa·s. when measured at a rotation speed of 5.6 rpm

35. A paint according to any one of claims 32, 33 or 34 having a low shear viscosity in the range of approximately 130 dPa·s to approximately 150 dPa·s. when measured at a rotation speed of 5.6 rpm

36. A paint according to any one of claims 27 to 35 also having an anti-sag index rating of between approximately 500 μm to approximately 1,100 μm.

37. A paint according to any one of claims 27 to 36, having an anti-sag index rating of between approximately 700 μm to approximately 800 μm.

38. A paint according to any one of claims 27 to 37, wherein the wet film thickness of the spray application of paint is from approximately 200 μm to approximately 700 μm when applied to a desired substrate.

39. A sprayable paint according to any one of claims 27 to 38 having a viscosity in the range of approximately 17 dPa·s to approximately 20 dPa·s (181 rpm) or a low shear viscosity of approximately 130 dPa·s to approximately 150 dPa·s (5.6 rpm) having an anti-sag index of approximately 700 μm to approximately 800 μm and applied by spraying to a wet film thickness of approximately 200 μm to approximately 700 μm.

40. A paint according to any one of claims 27 to 39, wherein the paint is a polyurethane modified acrylic paint.

41. A paint according to any one of claims 27 to 40, wherein said paint is pre-heated prior to spraying on desired substrate or surface.

42. The use of a paint according to any one of claims 27 to 41 for decorative purposes.

43. The use of a paint according to any one of claims 27 to 41 to protect substrates or surfaces.

44. A paint according to any one of claims 27 to 41 applied to a desired substrate or surface using the apparatus according to any one of claims 1 to 23.
